(19) United States
(12) Patent Application Publication
(10) Pub. No.: US 2023/0346640 A1
(43) Pub. Date: Nov. 2, 2023

(54) CLOSURE DEVICE

(71) Applicant: West Pharmaceutical Services Deutschland GMBH & Co. KG, Eschweiler (DE)

(72) Inventors: Kolja Richlowski, Aachen (DE); Carrington Lepley, Scottsdale, AZ (US)

(21) Appl. No.: 18/004,856

(22) PCT Filed: Jul. 2, 2021
(86) PCT No.: PCT/US2021/040349

§ 371 Date: Jan. 9, 2023

Related U.S. Application Data
(60) Provisional application No. 63/049,154, filed on Jul. 8, 2020.

(51) Int. Cl. A61J 1/14; B65D 41/46; B65B 7/28

(52) U.S. Cl. CPC A61J 1/1425; B65D 41/465; B65B 7/2842

(57) ABSTRACT

A closure device for sealing a container includes a stopper and a cap assembly. The cap assembly is configured to surround both the stopper and a neck of the container in a sealed condition and includes a ring portion and a crown portion. The ring portion contains the stopper and includes a plurality of locking tabs. The crown includes a skirt telescopically mounted over the ring and configured to radially deflect the plurality of locking tabs inwardly under an annular collar of the container when the crown is axially displaced towards the neck of the container. A method of sealing containers using the closure device is also provided.

### CROSS-REFERENCE TO RELATED APPLICATION

This application claims the benefit of and priority to U.S. Provisional Application No. 63/049,154, titled “CLOSURE DEVICE”, filed on Jul. 8, 2020, the entire content of which being incorporated by reference herein.

### BACKGROUND

A closure device for closing a container is provided, which in one embodiment, includes a preassembled stopper. Another embodiment relates to a container equipped with such a closure device.

In the field of containers for medication, a glass or polymeric bottle can be used to store an active ingredient in freeze-dried form, in powder form, or in the form of a liquid solution. Such a bottle must be closed off in a leak-tight manner, so as to maintain its contents in a satisfactory state of preservation, until the date on which it is used. In order to close a bottle hermetically, a closure device can be used that comprises an elastomeric stopper that has the function of sealing the opening of the container from the ingress or egress of gas, liquids, and bacteria. Such a device may further comprise a means for maintaining the container in a sealed condition, such as a crimped aluminum seal or plastic cap, that is designed to be held in place around the stopper so as to isolate the stopper from the outside and so as to oppose removal of the stopper.

When using such a closure device for freeze-dried pharmaceutical substances, for example, each container is filled with a quantity of substance for freeze-drying, and then the respective stopper is placed on or in the neck of the container in such a manner as to be secured thereto, while also preserving communication between the outside environment and the inside of the container. Containers filled and pre-stopped in this way are then placed in batches on the shelves of a freeze drier inside which the substances are dehydrated. During freeze-drying of the contents of a container, vacuum cold-drying is performed to help ensure that the water is extracted from the substance by sublimation and evaporation.

Once the substances have been dehydrated within the freeze drier, pressure is applied to all of the stoppers of the containers in such a manner so as to help ensure that the containers are stopped hermetically by each stopper being engaged on or within the opening of the neck of the corresponding container. Such stopping in batches is generally performed with the elastomeric stopper alone, without the sealing means. After removing the containers from the freeze drier, additional processing is performed to position the seal in place on each container. However, it is desirable to avoid such an additional operation. Thus, it has been envisaged to place the corresponding sealing means on each of the stoppers of the pre-stopped containers before freeze drying them, so that the sealing means may be applied substantially simultaneously while the stoppers are being pressed into place inside the freeze drier.

When the sealing means are applied, so as to be affixed around the neck of the corresponding container, friction creates resistance to this movement, the magnitude of which varies as a function firstly of the manufacturing tolerances of the component parts of the seal, and secondly of the pre-positioning of the parts when they are installed on the neck of the container. Thus, when a presser plate is used inside the freeze drier to lock the seals on a large number of corresponding containers, certain seals may not lock correctly in view of the manufacturing tolerances of the component parts of the seals and in view of the operating clearances of the presser plate. Also, the dimensional variations in the containers themselves and in the stoppers that are used further complicate the closure of a batch of containers.

Therefore, there is a need for improved closure devices which provide for secure and stable positioning of a sealing means on a vial stopper.

### BRIEF SUMMARY OF THE DISCLOSURE

In one aspect, a closure device is provided for sealing a container having a neck with an opening and an annular collar. The closure device comprises a stopper and a cap assembly. The cap assembly is configured to surround both the stopper and the neck in a sealed condition. The cap assembly comprises a ring and a crown. The ring contains the stopper and comprises a plurality of locking tabs. The crown comprises a skirt telescopically mounted over the ring and configured to radially deflect the plurality of locking tabs inwardly under the annular collar when the crown is axially displaced towards the neck of the container. A first locking tab of the plurality of locking tabs has a first axial height and a second locking tab of the plurality of locking tabs has a second axial height, wherein the first axial height is less than the second axial height.

In another aspect, a closure device is provided for sealing a container having a neck with an opening and an annular collar. The closure device comprises a stopper having a flange and a cap assembly. The cap assembly is configured to surround both the stopper and the neck in a sealed condition and comprises a ring and a crown. The ring contains the stopper and includes a plurality of locking tabs. The crown comprises a skirt telescopically mounted over the and is configured to radially deflect the plurality of locking tabs inwardly under the annular collar. The ring also comprises an inner circumferential surface including a plurality of raised steps extending inwardly radially from the inner circumferential surface to a diameter that is less than or equal to the diameter of the stopper flange.

These and other aspects of the various embodiments disclosed herein will be apparent in view of the following description.

### BRIEF DESCRIPTION OF THE SEVERAL VIEWS OF THE DRAWINGS

Various aspects and embodiments of the application will be described with reference to the following figures. It should be appreciated that the figures are not necessarily drawn to scale. The figures depict one or more implementations in accord with the present concepts, by way of example only, not by way of limitations. In the figures, like reference numerals may refer to the same or similar elements.

FIGS. 1 to 5 are axial cross-sectional and a sectional perspective schematic views of the several stages of filling, drying, and sealing a product in containers sealed with a closure device according to the disclosure;

FIG. 6A is a top perspective view of a closure device according to an embodiment disclosed herein;

FIG. 6B is an exploded view of the closure device of FIG. 6A;

FIG. 7A is a top perspective view of a removable lid included in the closure device disclosed herein;

FIG. 7B is a top plan view of the removable lid of FIG. 7A;

FIG. 7C is a bottom plan view of the removable lid of FIG. 7A;

FIG. 7D is a front view of the removable lid of FIG. 7A;

FIG. 7E is a cross-sectional front view of the removable lid of FIG. 7A;

FIG. 8A is a top perspective view of a crown included in the closure device disclosed herein;

FIG. 8B is a top plan view of the crown of FIG. 8A;

FIG. 8C is a bottom plan view of the crown of FIG. 8A;

FIG. 8D is a front view of the crown of FIG. 8A;

FIG. 8E is a cross-sectional side view of the crown of FIG. 8A;

FIG. 9 is a cross-sectional front view of the combination of the lid and crown in the closure device disclosed herein;

FIG. 10A is a top perspective view of a ring included in the closure device disclosed herein;

FIG. 10B is a top plan view of the ring of FIG. 10A;

FIG. 10C is a bottom plan view of the ring of FIG. 10A;

FIG. 10D is a front view of the ring of FIG. 10A;

FIG. 10E is a bottom perspective view of the ring of FIG. 10A;

FIGS. 10F and 10G are cross-sectional front and side views, respectively, of the ring of FIG. 10A;

FIG. 10H is a bottom plan view of another embodiment of a ring;

FIG. 11 is a cross-sectional front view of the closure device of FIGS. 6A and 6B;

FIG. 12A is a large scale view of the detail VI in FIG. 3;

FIG. 12B is a large scale view of the detail X in FIG. 4,

FIG. 12C is a cross-section according to the line XI-XI in FIG. 12B,

FIG. 12D is a cross-section similar to FIG. 12C during an intermediary stage between the configurations of FIGS. 4 and 5,

FIG. 12E is larger scale view of the detail XIII of FIG. 5 and

FIG. 12F is a cross section according to the line XIV-XIII of FIG. 12E.

### DETAILED DESCRIPTION

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the liquid transfer device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

It will also be appreciated by those skilled in the art that modifications may be made to the exemplary embodiments described herein without departing from the invention. Structural features of systems and apparatuses described herein may be replaced with functionally equivalent parts. Moreover, it will be appreciated that features from the embodiments may be combined with each other without departing from the disclosure.

Generally, the closure devices according to the various embodiments disclosed herein comprise a stopper and sealing means provided in the form of a cap assembly. The stopper is loaded within the cap assembly, and the closure device may be applied to the opening of a container, such as a vial, to capture an annular collar around the neck of the container and maintain the stopper in a sealed condition.

The closure devices according to the various embodiments disclosed herein may be used in typical filling and lyophilization processes, such as those described in U.S. Pat. No. 8,714,384, the content of which is incorporated by reference herein in its entirety. For example, referring to FIGS. 1 to 5, different stages of packaging a product P in glass bottles constituting the containers is illustrated. The bottles 1 may alternatively be made of a ceramic or a polymeric material, such as polyethylene (PE), polyethylene terephthalate (PET), glycol-modified polyethylene terephthalate (PETG), high density polyethylene (PEHD) and the like.

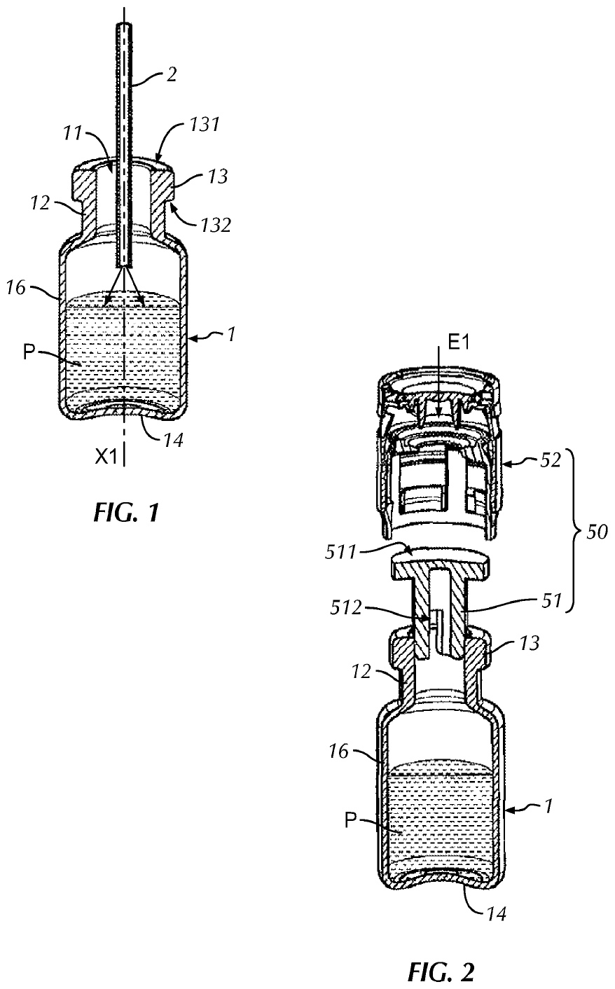

In FIG. 1, bottle 1 is in the process of being filled with product P, for example, a medication. Pipette 2 is introduced into bottle 1 through its mouth 11 which is defined by a neck 12 presenting an outer collar 13. X1 shows the symmetrical axis of bottle 1. When a predetermined quantity of product P has been introduced into bottle 1, pipette 2 is withdrawn and a closure device 50, as illustrated in FIG. 2, is placed on neck 12. The device 50, comprises an elastomeric stopper 51 adapted to be partially introduced into the mouth 11, while remaining on the side 131 of the collar 13 opposite the bottom 14 of the bottle 1. A filling line may include a plurality of pipettes in order to simultaneously fill multiple containers. Similarly, an automated filling line may also be capable of simultaneously applying a plurality of stoppers and cap assemblies to the container after the containers are filled with product.

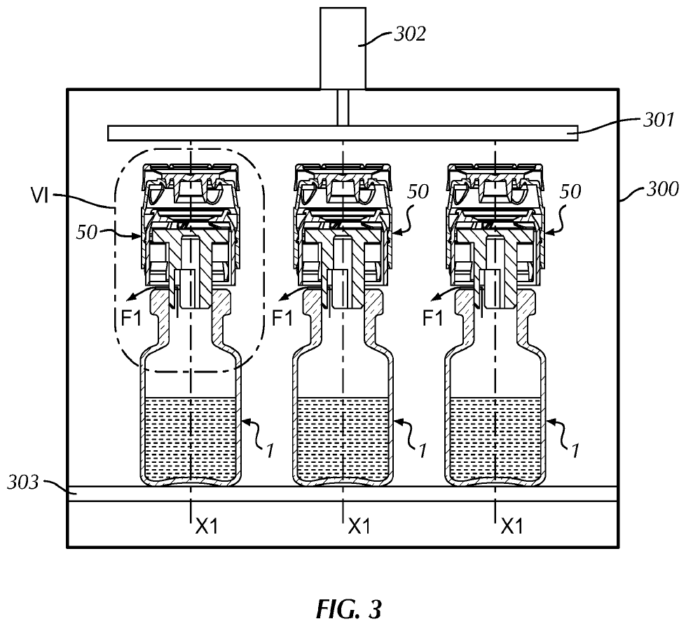

The device 50 also comprises a cap 52 aimed at covering and maintaining the stopper 51 and the neck 12 in a closed configuration. The stopper 51 is preferably pre-loaded into the cap 52 and held in an axial position prior to affixing the cap onto the neck 12 of the bottle 1, described in greater detail below. After filling the closure device 50 is applied to the neck 12 of each container 1, such that the stopper 51 does not completely fill the mouth 11. The stopper 51 is preferably provided with a vent 512 which communicates with the atmosphere on the exterior of the container 1. A plurality of filled containers 1 having a closure device 50 applied thereon may then be loaded into a lyophiliser 300, as illustrated in FIGS. 3 to 5 as one lot of bottles 1. In FIGS. 3 to 5, three bottles represent one lot which can comprise several hundred, or even several million, bottles used in the lyophiliser 300. Moreover, the bottles may be loaded into a lyophiliser on several stacked shelves. After loading the containers 1 into the lyophiliser, the internal temperature and pressure within the lyophiliser is reduced until the water present in each bottle 1 is vaporized and exits the container through the vents 512 in the stoppers 51 and the space between cap 52 and the collar 13, as represented by the arrows F1 in FIG. 3.

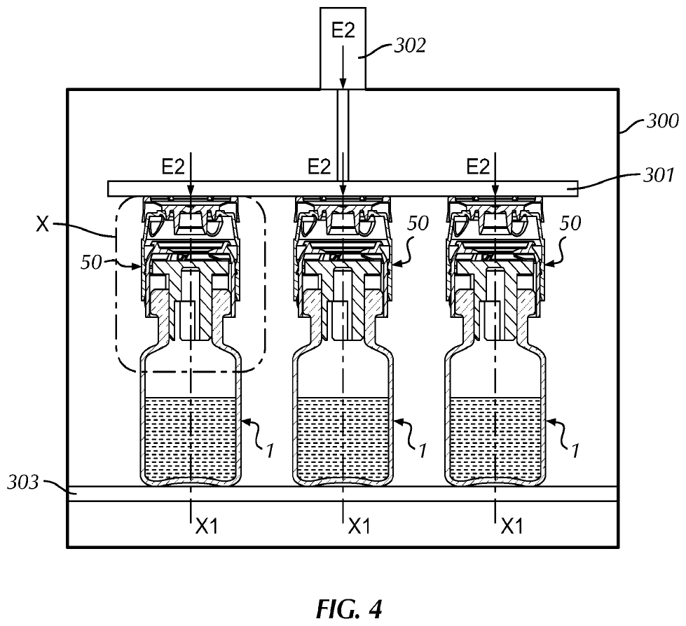

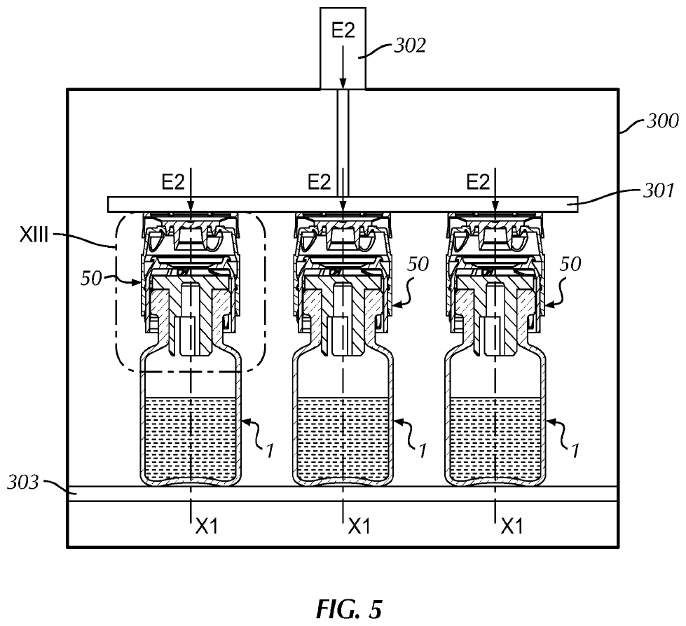

After expelling a pre-determined amount of water, such that the product P is sufficiently dry, a press 301 may apply a force E2 over all of the closure devices 50 inside the lyophiliser, as represented in FIGS. 4 and 5. The force E2 is evenly applied on the devices 50 parallel to the longitudinal axis X1 of the bottles 1 and the necks 12. This axial force E2 exerted by the press 301 inside the lyophiliser may be pneumatically controlled or by a mechanical jack 302, for example. The force E2 applied by the press 301 causes axial displacement of the closure devices 50 towards their respective containers 1. As a result, the elastomeric stoppers 51 are first inserted to a depth within the openings 11 in each container 1, such that the vents 512 are no longer exposed and the contents P of the containers 1 are isolated from the exterior of the containers 1, and second, further depression of the closure devices 50 by the press 301 causes the caps 52 to capture the respective necks 12 of each container 1, thereby compressing and sealing the stoppers 51 against the top sides 131 of the necks 12 of the containers 1.

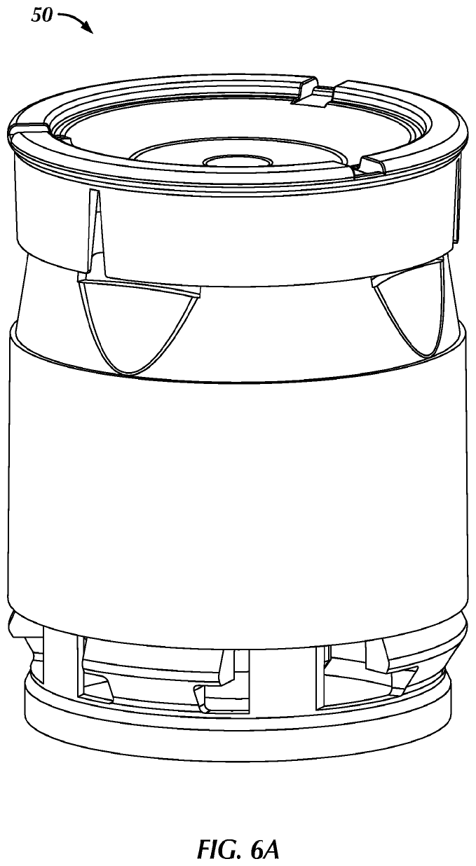

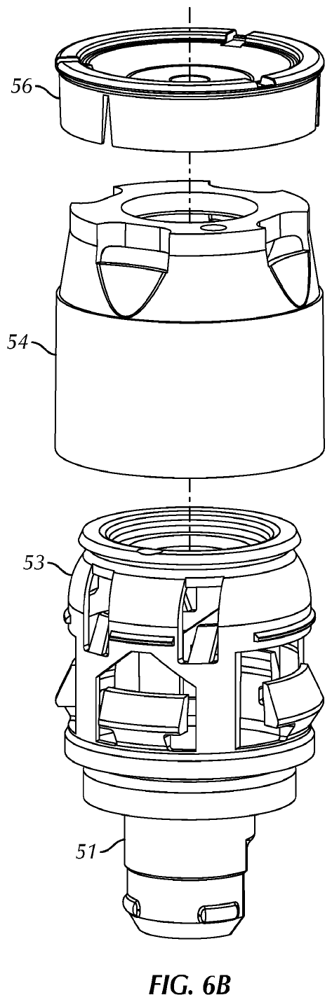

Referring now to FIGS. 6A to 11, a closure device 50 according to an embodiment is illustrated. As previously described, the closure device comprises an elastomeric stopper 51, a ring portion 53, a crown portion 54, and a lid 56. The lid 56 is attached to the crown portion 54 and is preferably configured to be easily removed by one hand of the user, for example. The closure device 50, and more particularly each component of the closure device 50 as described in detail herein, is preferably made of a plastic material, and more preferably a thermoplastic material such as, but not limited to, PE, PET, PETG, PEHD, polypropylene (PP) or acrylonitrile butadiene styrene (ABS). More preferably, the closure device 50 is made of a pharma grade polypropylene material, and more particularly a pharma grade polypropylene material that is free of contaminants or critical substances (e.g., bisphenol A or formaldehyde).

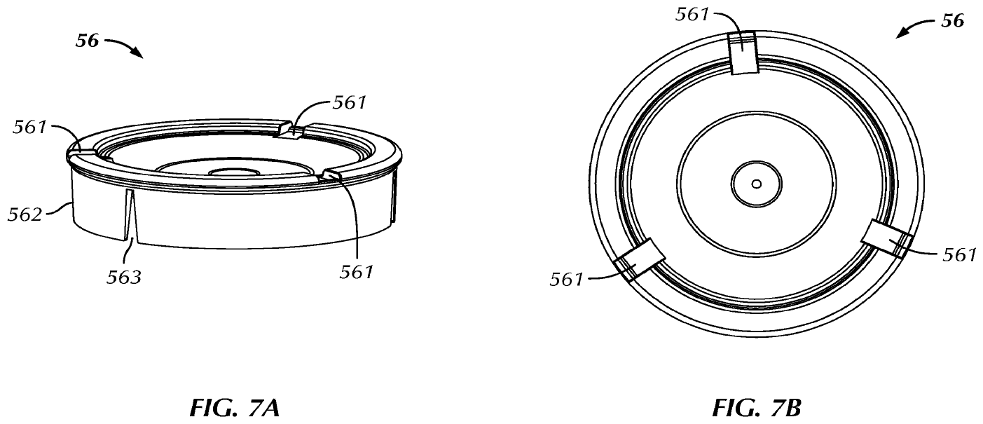

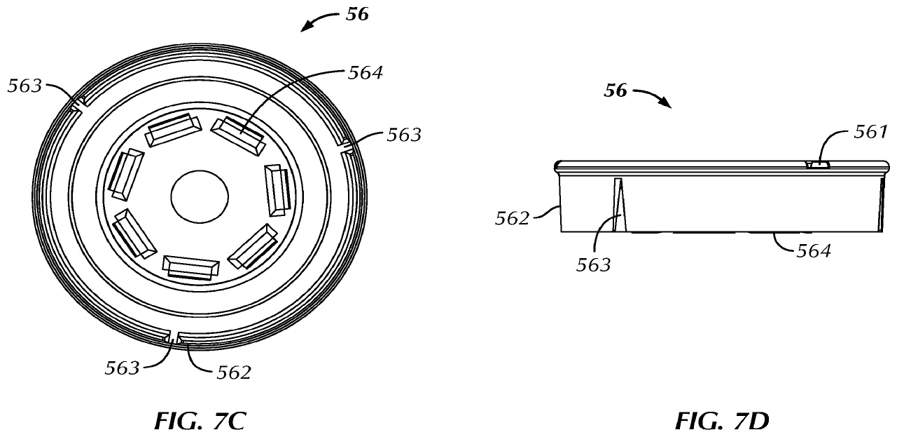

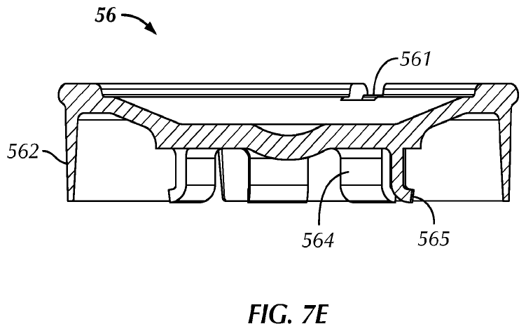

As best viewed in FIGS. 7A to 7E, the lid 56 comprises a top portion that may optionally include a plurality of notches 561 around the perimeter of the top surface of the top portion. The notches 561 may facilitate the centering and application of force by an automated manufacturing line to attach the lid 56 to the crown 54. A lid skirt 562 may downwardly extend from the top portion of the lid 56, and a plurality of axially extending cuts 563 may be provided in the lid skirt 562 to more easily deform and separate the lid 56 from the crown 54 when a user intends to access the stopper 51. The lid 56 may further comprise a plurality of deformable tabs 564 that extend axially from the underside of the top portion of the lid 56 for attaching the lid 56 to the crown 54.

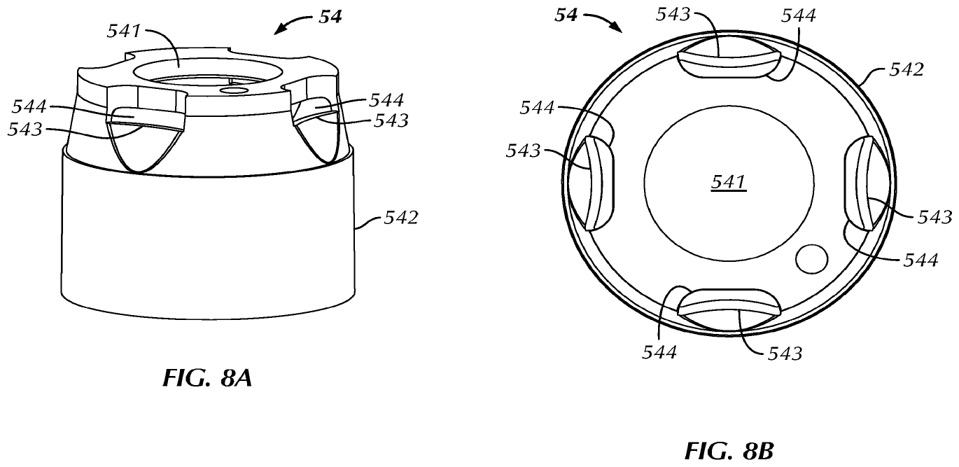

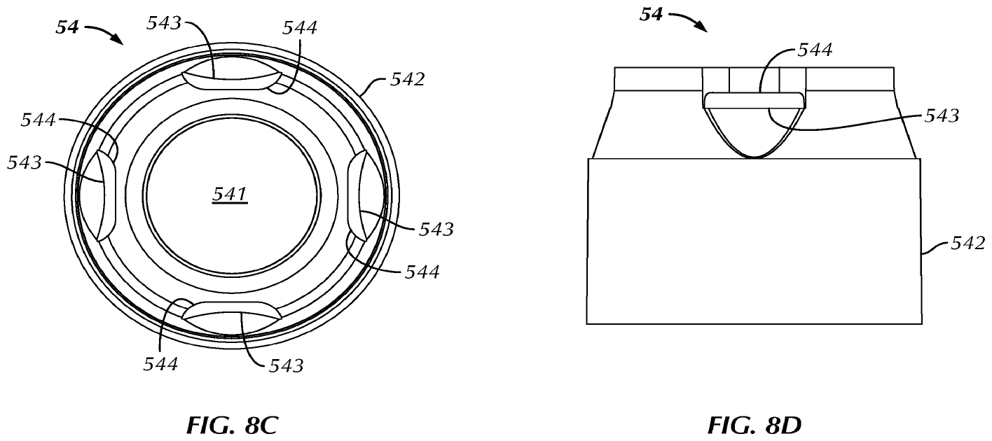

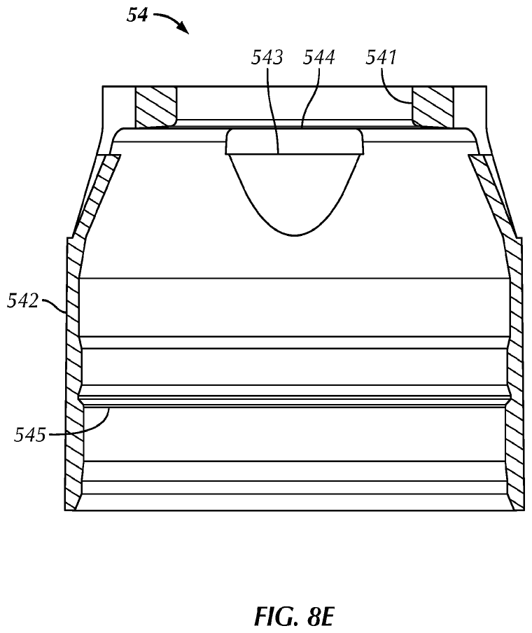

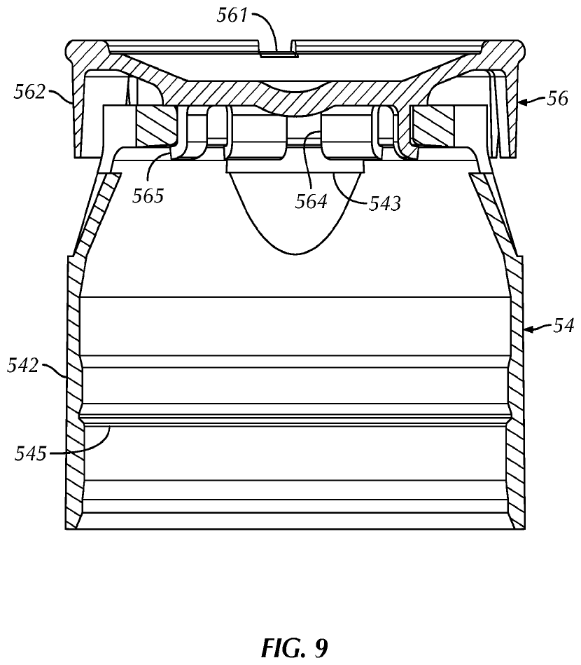

As best viewed in FIGS. 8A to 8E, the crown 54 includes a top portion having a centrally located aperture 541, as well as a crown skirt 542 downwardly extending from the top portion and is intended to constitute the external peripheral envelope of the closure device 50. The circumferential wall of the crown skirt 542 includes a plurality of radially inwardly protruding arcuate ledges 543 for providing a surface that may be captured by the ring portion 53 in the sealed condition, described in greater detail below. Above each ledge 543 is an opening 544. The ledges 543 and openings 544 are preferably equidistantly spaced about a common circumference of the skirt 542. Referring to FIG. 9, the lid 56 and crown 54 are illustrated in the assembled condition. The plurality of tabs 564 are inserted through the aperture 541 of the crown 54 and the tabs 564 are deformed in order to provide each of the tabs 564 with a lip 565 that captures the underside of the top portion of the crown 54.

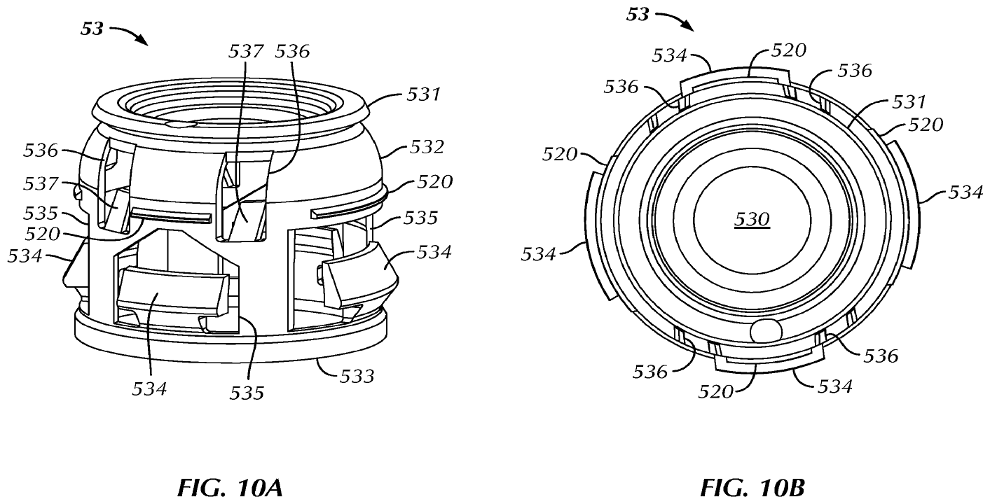

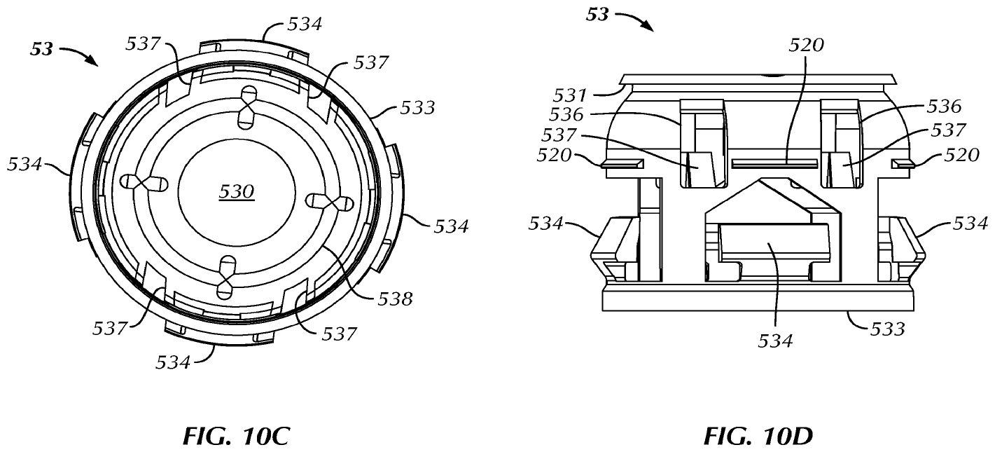

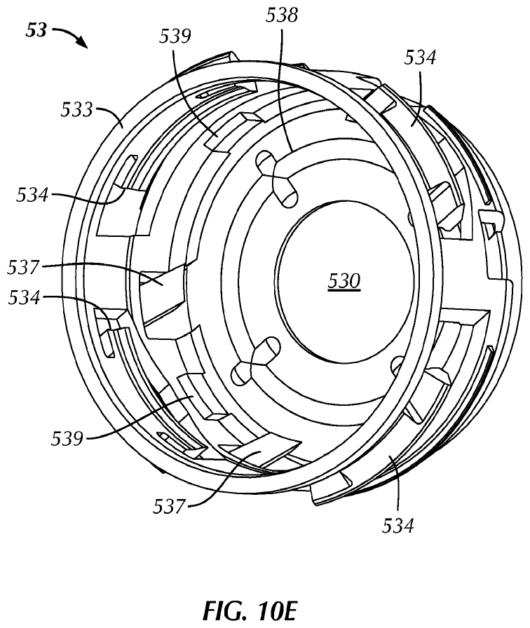

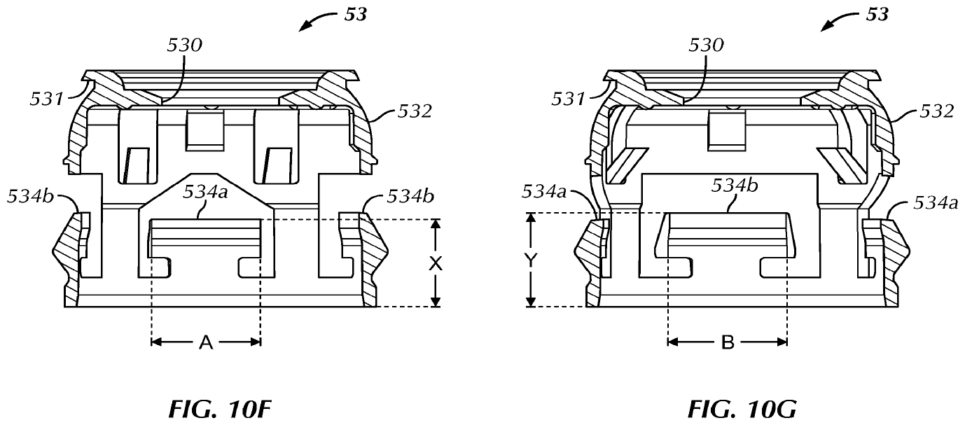

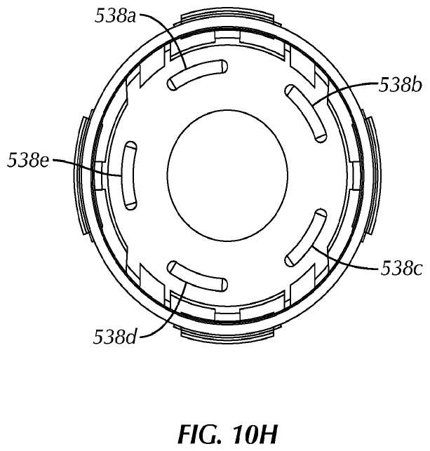

Referring to FIGS. 10A to 10F, the ring portion 53, similar to the crown portion 54, includes a top portion having a centrally located aperture 530 and a skirt portion 532 downwardly extending from the top portion. The ring portion 53 includes a circular interior section whose internal diameter is sufficient to allow it to surround the collar 13 of the vial 1. The top portion is further provided with a collar 531 configured to catch the ledges 543 of the crown 54 when the closure device 50 is in the sealed condition, described in greater detail below. A bottom portion 533 of the ring 53 located on an opposing end of the ring 53 relative to the top portion includes a plurality of axially extending resilient locking tabs 534, wherein the distal end of the locking tabs 534 (i.e. the end of the locking tabs 534 closest to the bottom portion 533) are preferably hingedly attached to the bottom portion 533. Each of the locking tabs 534 are located within a window 535 in the circumferential wall of the ring skirt 532. As best viewed in FIGS. 10F and 10G, the ring 53 preferably comprises two pairs of locking tabs 534a and 534b, wherein the locking tabs 534a of the first pair being located in opposing relation to each other about the circumference of the ring skirt 532 and the locking tabs 534b of the second pair being located in opposing relation to each other about the circumference of the ring skirt 532. The locking tabs 534a of the first pair have an axial height X and a circumferential width A, and the locking tabs 534b of the second pair have an axial height Y and a circumferential width B, wherein the axial height X is less than the axial height Y and the circumferential width A is less than the circumferential width B.

The circumferential wall of the ring skirt 532 is also provided with plurality of circumferential ribs 520 and a plurality of apertures 536 located at an axial height between the collar 531 and the locking tabs 534. Each of the apertures 536 includes an inwardly radially extending retaining arm 537 attached to the lower edge of the aperture 536.

As best viewed in FIGS. 10C and 10E, the ring 53 may further comprise a circular protuberance 538 on the bottom surface of the top portion around the centrally located aperture 530. The protuberance 538 ensures that an evenly distributed force is applied to the top surface of the stopper 51, when the closure device is in a sealed condition. As illustrated in FIG. 10E, the circular protuberance 538 is in the form of a continuous circle. In other embodiments, such as the ring illustrated in FIG. 10H, the circular protuberance may comprise a plurality of segments 538a, 538b, 538c, 538d, 538e. The segments are preferably of equal size and spaced evenly to ensure the aforementioned evenly distributed force when the closure device in the sealed condition. Increasing the space between each of the plurality of segments also reduces the force necessary to compact the closure device and achieve the sealed condition.

Prior to affixing the closure device 50 to a container, the stopper 51 is preloaded into the ring portion 53. In order to ensure that the stopper 51 remains within the ring portion 53, the previously mentioned retaining arms 537 extend inwardly to a diameter that is less than the diameter of the flange 510 of the stopper 51, thereby, retaining the stopper 51 within upper inner chamber of the ring portion 53. To further retain the stopper 51 within the upper chamber of the ring portion 53, the inner circumferential surface of the skirt 532 adjacent to the top portion of the ring 53 is provided with a plurality of raised steps 539. The raised steps 539 extends inwardly radially to a diameter that is less than or equal to the diameter of the stopper flange 510 in order to provide an interference fit between the stopper 51 and the inner chamber of the ring 53. However, it is preferred that the raised steps 539 are only present along a portion of the inner circumference of the upper chamber adjacent the top portion of the ring 53 in order to minimize the force necessary to compress the stopper flange 510 and lock the closure device 50 in the sealed condition. The raised steps 539 are present, with increasing preference in the order presented, about 50% or less, 45% or less, 40% or less, 35% or less, 30% or less, 25% or less, 20% or less, 15% or less, 10% or less, or 5% or less of the inner circumference of the ring skirt 532.

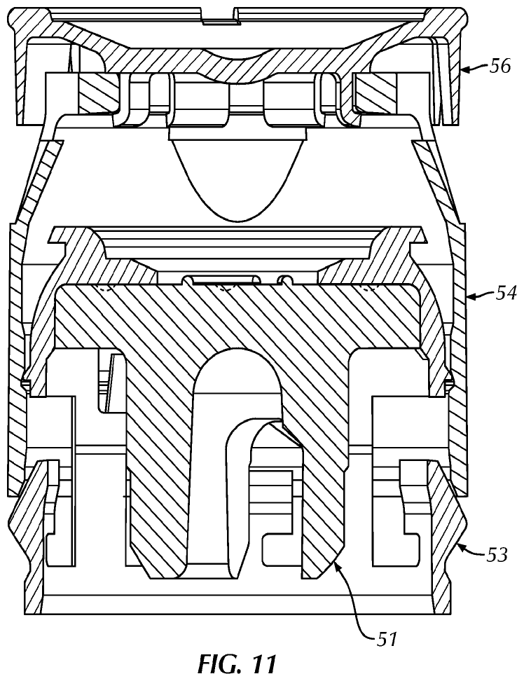

After affixing the lid 56 to the crown 54 and loading the stopper 51 into the ring 53, the crown 54 is then telescopically mounted over the ring 53 the plurality of circumferential ribs 520 of the ring 53 mates with an inner circumferential groove 545 of the crown 54, thereby providing the closure device 50 in an assembled condition, as best viewed in FIG. 11.

In practice, the geometry of ring 53, crown 54 and lid 56 is chosen in such a way that the maximum exterior diameter of the crown 54 has a value less than 13.5 mm, more preferably between 12.8 and 13.2 mm, and most preferably less than or equal to 12.8 mm. In these conditions, when one uses a vial 1 whose body 16 has a diameter equal to 13 mm, the closure device 50 mounted onto the vial 1 does not exceed or slightly exceeds the diameter of the vial 1. This reduces the likelihood that the bottles will be imbalanced and easily tip over when the closure device 50 is applied or during lyophilization.

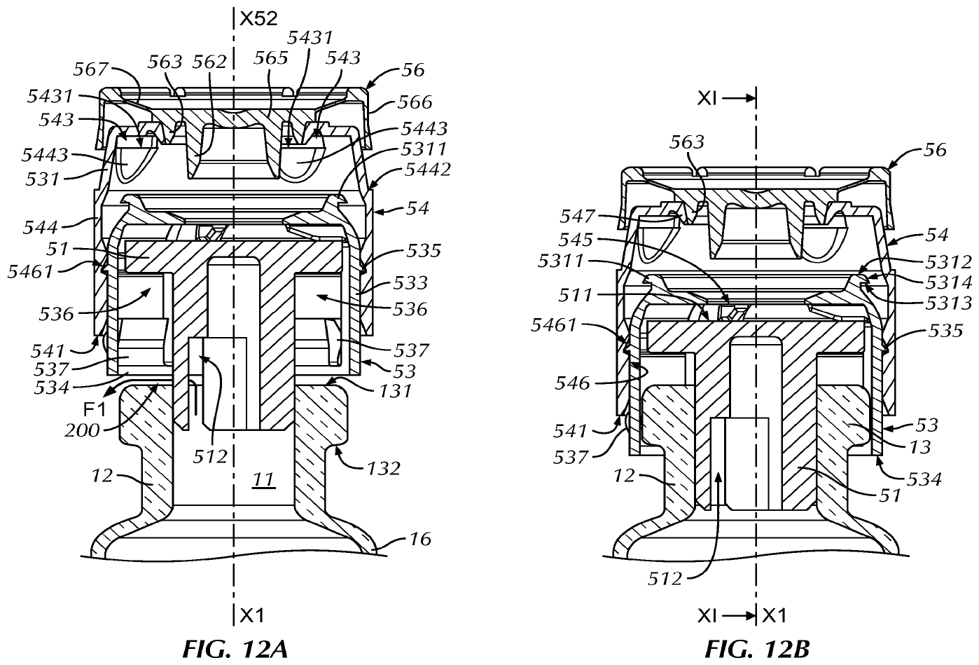

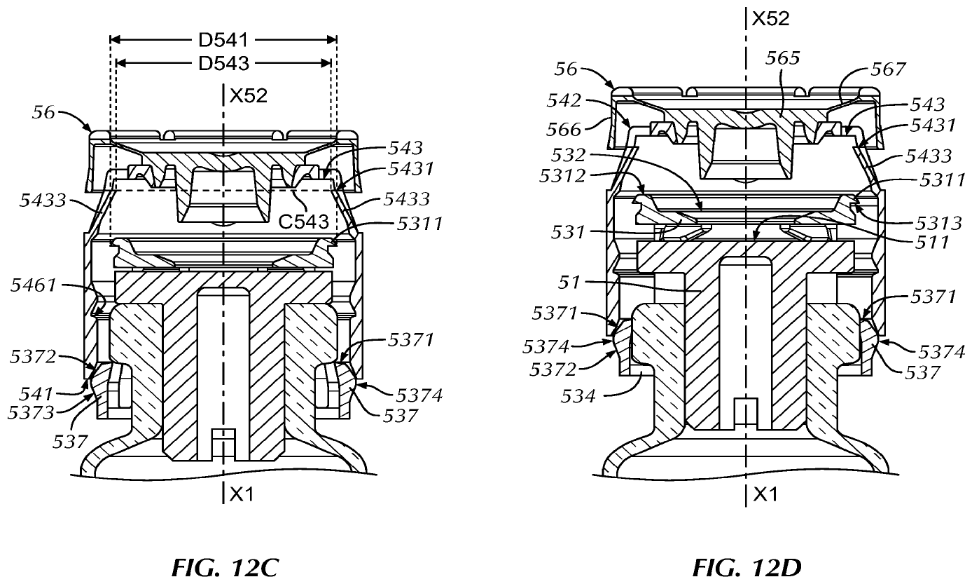

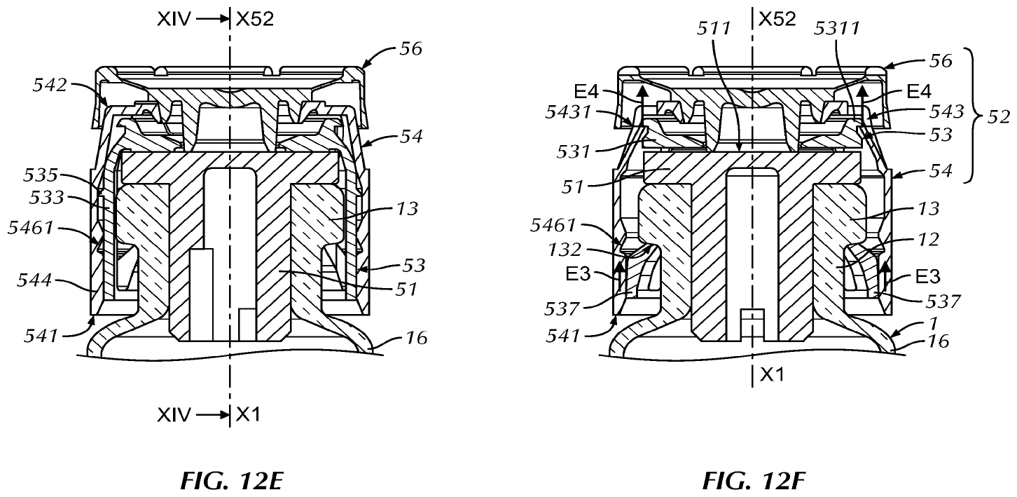

A method of sealing a vial using a closure device according to another embodiment disclosed herein will be described with reference to FIGS. 12A to 12F. In the configuration in FIGS. 12A and 12B, a crown 54 is in a holding configuration in which external ribs 535 of a ring 53 remain inserted in an inner peripheral groove 5461 of the crown 54. In this configuration, the crown 54 does not interact with locking tabs 537 of the ring 53.

Applying a force E2 has the effect of making the crown 54 move in the direction of the bottom 14 of each of the vials 1, as represented by the passage from the configuration in FIGS. 3 and 12A to that of FIGS. 4 and 12B. The E2 force is transmitted from the crown 54 to the ring 53 because of the interference fit between the peripheral groove 5461 and the external ribs 535 which cooperate. Thus, external ribs 535 and the peripheral mouth 5461 constitute the force transmission means E2 from the crown 54 to the ring 53. The force E2 exerted on each device 50 has the effect of sliding the tabs 537 of the ring 53 along the outer surface of the vial collar 13, and ultimately under the vial collar 13. The retaining arms 537 also impinge and slide along the outer surface of the vial 13, thereby causing the retaining arms 537 to deflect radially outwards and into their respective apertures 536, such that the retaining arms 537 no longer contact or interfere with the bottom surface of the stopper flange 510 and allow the stopper to be inserted into the opening of the vial 1.

The top section of the ring 53 contacts with the upper surface 511 of the stopper 51 which halts the progression of the ring 53 in the direction of the base 14. The continued application of the force E2 on the crown 54 of each device 50 has the effect of driving the external rib 535 of the ring out of the peripheral groove 5461 by elastic deformation of the skirt 533, which allows the crown 54 to successively attain the position of FIGS. 12E and 12F. This allows the edge 541 of the crown 54 to make contact with the surfaces 5372 of the different locking tabs 537, as represented in FIGS. 12C and 12D. The continuation of this movement has the effect of making the surfaces 5372 slide against the edge 541, which flaps the tabs 537 radially towards the axis X1, by moving their free side 5371 against the inferior peripheral surface 132 of the collar 13, as represented in FIG. 12F. Thus, the edge 541 allows the locking tabs 537 to be put into an active configuration where they immobilise the cap 52 on the neck 12.

This movement also has the effect of causing ledges 5431 below the openings 543 in the crown 54 to catch the undersurface 5313 of the annular collar 5311 of the ring 53. D531 shows the maximum diameter of the annular collar 5311. D543 shows the minimum diameter shared by the radially innermost points of each of the ledges 5431 towards an axis X52. The zones 5443 below the arcuate ledges 5431 are elastically deformed by sliding against the surface 5314 of the ring collar 5311, while passing from the configuration of FIG. 12D to the configuration of FIGS. 12E and 12F. The resiliency of zones 5443 cause the zones 5443 to revert to their original shape after the ledges 5431 are below the annular collar 5311, such that the annular collar 5311 provides a catch or stop preventing any separation between the crown 54 and the ring 53 that may occur from vertical axial displacement of the crown 54 relative to the ring 53. Therefore, if a withdrawal force E3 of the crown 54 is exerted on the closure device, as represented in FIG. 12F, both the ledges 5431 will be impeded by the annular collar 5311 and the locking 537 will be impeded by the vial collar 13.

The result of this is a particularly effective locking of the crown 54 around the ring 53, in the configuration of FIGS. 12E and 12F. Once the closure device 50 is mounted on the neck 12 of a vial 1, the only way to access the stopper 51, and through this, the contents of the vial 1, is to remove the lid 56 by separating the lid 56 from the crown 54.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A closure device for sealing a container having a neck with an opening and an annular collar, the closure device comprising:
a stopper; and
a cap assembly configured to surround both the stopper and the neck in a sealed condition, the cap assembly comprising:
a ring containing the stopper and comprising a plurality of locking tabs, and a crown comprising a skirt telescopically mounted over the ring, the skirt being configured to radially deflect the plurality of locking tabs inwardly under the annular collar when the crown is axially displaced towards the neck of the container,
wherein a first locking tab of the plurality of locking tabs has a first axial height and a second locking tab of the plurality of locking tabs has a second axial height the first axial height being less than the second axial height.

2. The closure device of claim 1, wherein the first locking tab of the plurality of locking tabs has a first width and the second locking tab of the plurality of locking tabs has a second width, the first width being less than the second width.

3. The closure device of claim 1, wherein the stopper includes a flange and the ring further comprises a plurality of retaining arms configured to extend radially inward and contact a surface of the flange in an unsealed condition.

4. The closure device of claim 3, wherein the ring further includes a plurality of apertures and each aperture is adjacent to one retaining arm of the plurality of retaining arms, such that upon axial displacement of the ring towards the neck, the annular collar deflects each of the retaining arm into the respective adjacent aperture and the stopper is inserted into the opening in the sealed condition.

5. The closure device of claim 1, wherein the stopper has a flange, and the ring has an inner circumferential surface including a plurality of raised steps extending inwardly radially from the inner circumferential surface to a diameter that is less than or equal to the diameter of the flange.

6. The closure device of claim 5, wherein the plurality of raised steps are present in less than 50% of an inner circumference of the ring.

7. A container equipped with the closure device of claim 1.

8. A method of sealing a container with the closure device of claim 1, the method comprising:
inserting the neck of the container into the ring; and
applying an axial force until the stopper is inserted into the opening in the neck of the container and the plurality of locking tabs are radially deflected under the annular collar.

9. A closure device for sealing a container having a neck with an opening and an annular collar, the closure device comprising:
a stopper having a flange; and
a cap assembly configured to surround both the stopper and the neck in a sealed condition, the cap assembly comprising:
a ring containing the stopper and including a plurality of locking tabs, and
a crown comprising a skirt telescopically mounted over the ring, the skirt being configured to radially deflect the plurality of locking tabs inwardly under the annular collar,
wherein the ring comprises an inner circumferential surface including a plurality of raised steps extending inwardly radially from the inner circumferential surface to a diameter that is less than or equal to the diameter of the flange.

10. The closure device of claim 9, wherein the plurality of raised steps are present in less than 50% of an inner circumference of the ring.

11. The closure device of claim 9, wherein the ring further comprises a plurality of retaining arms configured to extend radially inward and contact a surface of the flange in an unsealed condition.

12. The closure device of claim 11, wherein the ring further includes a plurality of apertures and each aperture is adjacent to one retaining arm of the plurality of retaining arms, such that upon axial displacement of the ring towards the neck, the annular collar deflects each of the retaining arm into the respective adjacent aperture and the stopper is inserted into the opening in the sealed condition.

13. A method of sealing a container with the closure device of claim 9, the method comprising:
inserting the neck of the container into the ring; and
applying an axial force until the stopper is inserted into the opening in the neck of the container and the plurality of locking tabs are radially deflected under the annular collar.

14. A container equipped with the closure device of claim 9.
